(19) United States
(12) Patent Application Publication
(10) Pub. No.: US 2015/0224456 A1
(43) Pub. Date: Aug. 13, 2015

(54) Fluid Displacement Regulated Line Feed System

(71) Applicant: Steven Michael Waltman, Kalispell, MT (US)

(72) Inventor: Steven Michael Waltman, Kalispell, MT (US)

(21) Appl. No.: 14/176,073

(22) Filed: Feb. 8, 2014

(51) Int. Cl. B01F 5/04

(52) U.S. Cl. CPC B01F 5/04

(57) ABSTRACT

A liquid additive feed system integrateable into a pressure controlled fluid flow line, which may include a liquid reservoir, a manifold, a flow line pressure regulation module, a flow controlled inlet line, a flow controlled feed line, and a diffusion interface, which dynamically adjustably delivers a metered dosage of liquid additive into a controlled aqueous flow delivery system.

### CROSS-REFERENCE TO RELATED APPLICATIONS

This application claims the benefit of patent application Ser. No. 12/860,312, filed 20 Aug. 2010, which claimed the benefit to patent application No. 61/235,353, filed 20 Aug. 2009 by the present inventor.

### STATEMENT REGARDING FEDERALLY SPONSORED RESEARCH OR DEVELOPMENT

Not Applicable

### BACKGROUND OF THE INVENTION

1. Field of the Invention

This invention relates to fluid injection systems for controllably diffusing an additive into a fluid flow. It also relates more specifically to aqueous or water-soluble substance delivery or additive systems that employ a reservoir to contain the additive prior to delivery.

2. Description of the Related Art

A variety of means have been used to blend soluble additives into fluid streams. A widely used device for garden-type applications is a Venturi suction device attached to a jar at the end of a garden hose. Attached to the fluid suction point typically is a tube to the bottom of the jar, which slowly draws the additive from the jar and introduces it into the fluid stream. The rate of introduction is difficult to regulate, since it varies depending on a multitude of conditions; few of which are reliably controllable by this type device.

A number of systems have developed to attempt to reliably control the variety of variable conditions that affect the additive dosage rate. For the most part, these address issues of handling safety and efficient use of the additive. The following patents exemplify some of the solutions.

U.S. Pat. No. 4,846,214 issued to Thomas F. Strong on Jul. 11, 1989, discloses a fluid additive injector designed to tap a portion of a fluid flow from a flow line and communicate that portion to the bottom of a reservoir that also contains an additive intended for injection. As the blend of flow fluid and additive liquid fills the reservoir the upper level at a point accesses the entrance of an outlet tap positioned in the top of the reservoir and the blend flows through the outlet tap. The outlet tap communicates the liquid blend into the fluid flow in the flow line.

U.S. Pat. No. 5,005,601 issued to Thomas F. Strong on Apr. 9, 1991, discloses a multi-tank proportioning fertilizer injector, where at least one tank is initially filled with air and at least one tank is initially filled with liquid fertilizer. An air tank is connected to a fluid flow line so that fluid slowly fills the air tank, compressing and displacing air into the fertilizer tank. The fertilizer tank is in communication with the fluid flow line so that as air is forced into the fertilizer tank fertilizer is injected into the fluid flow line.

U.S. Pat. No. 7,093,606 issued to Kenneth J. Roberts on Aug. 22, 2006, discloses a liquid fertilizer injector system that employs a holding tank connected to an inlet line communication a portional flow from a fluid flow line. A collapsible impermeable bag is positioned within the holding tank to contain and segregate a distinct additive apart from the fluid entering the holding tank via the inlet line. Fluid from the inlet line causes communication of additive from the bag out an outlet line and into the fluid flow downstream of the inlet line.

U.S. Pat. No. 4,165,759 issued to Alfred D. Tucker on Aug. 28, 1979, discloses a method of and device for delivering measured quantities of liquid into a fluid. A pressure differential is created in a fluid flow line and fluid is passed from the higher pressure side to a positive displacement fluid pump and returned therefrom to the lower pressure side. The fluid pump feeds liquid to mingle with the fluid before it is returned to the fluid flow line.

U.S. Pat. No. 4,406,406 issued to Philip B. Knapp on Sep. 27, 1983, discloses an apparatus for spraying plants that includes a reusable container having inlet and outlet hose connections, and a disposable cartridge which is inserted into the container. The cartridge comprises a pressure-sensitive container in the form of a piston cylinder or a collapsible bag containing the liquid chemical, and is mounted within a rigid casing or jar communicating with a stream of water under pressure entering the inlet hose connection. The stream of water also flows through an axial bore in the head of the reusable container to the outlet hose connection, passing from a high pressure side through a mixing chamber to a low pressure side. The pressure sensitive container has a precisely-dimensioned outlet aperture communicating with the mixing chamber so that liquid concentrate is forced under pressure from the pressure-sensitive container of the cartridge and mixes with the flow of water in a precise pre-selected micro-dispensing ratio, regardless of the pressure of the water supplied to the apparatus.

U.S. Pat. No. 3,166,096 issued to Helmut Lang on Jan. 19, 1965, discloses a dispenser for liquid additives to fluid streams comprising a rigid vessel subdivided by a freely displaceable pressure-responsive member into two compartments of which one, containing the additive to be supplied, is connectable to the low-pressure side of the main conduit while the other is connectable to the high-pressure side thereof. As the fluid from the upstream side of the conduit enters the initially empty expansible compartment its relatively elevated pressure forces the additive from the dispenser into the downstream side of the conduit at a adjustably measured rate proportional to the existing pressure differential of the flow of the main stream.

U.S. Pat. No. 5,337,930 issued to Jim Fah and Mike Lee on Aug. 16, 1994, discloses apparatus for adding fertilizer concentrate to a stream of flowing water, such that a relatively constant ratio of fertilizer to water is achieved. Pressurized water is diverted from a water passage into a container to achieve a fertilizer pumping action. A bag-like membrane in the container forms a pressurized water space that is in pressure contact with a separate fertilizer-containment space. Fertilizer concentrate in contact with the membrane is thus pumped out of the container and into a stream of water flowing through the water passage. A constriction is provided in the water passage to achieve a pressure drop that produces the desired pumping action.

Though the aforementioned patents may provide means of supplying a fixed amount of liquid solution they fail to provide an adjustable means for reliably delivering a specific dosage of additive to the plant, or other object to be treated, from a simple, unitary reservoir. It would be a valuable addition to the art to provide a simple, adjustably dynamic system for delivering a metered dosage of liquid additive from a unitary reservoir through a controlled aqueous feed system.

### BRIEF DESCRIPTION OF THE DRAWINGS

The invention will be explained in conjunction with an illustrative embodiment shown in the accompanying drawings, in which:

FIG. 1 is a partially cut-away perspective view of an exemplary embodiment of the present device shown schematically integrated into a flow system; and

FIG. 2 is a schematic side view of an alternate exemplary manifold.

### DESCRIPTION OF THE ILLUSTRATED EMBODIMENT

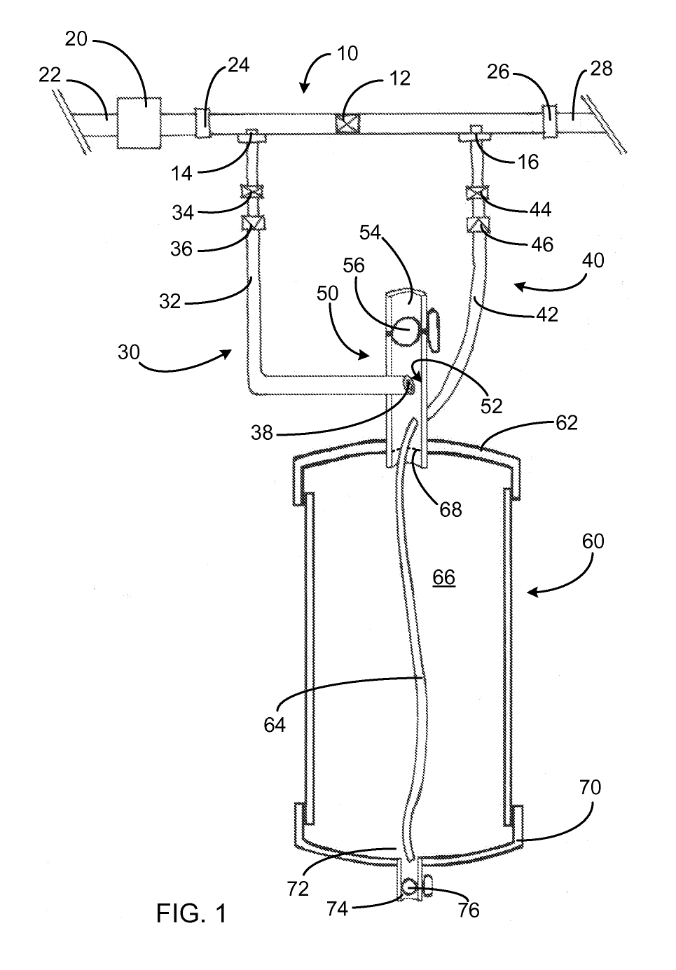

Now, referring to FIG. 1, an exemplary liquid additive feed system integrateable into a pressure controlled fluid flow line, is shown to include a liquid reservoir 60, a manifold 10, a flow line pressure regulation module 20, a flow controlled inlet line 30, a flow controlled feed line 40, and a diffusion interface 50. The liquid reservoir 60 is oriented with a top and a bottom, so that a liquid additive with a specific gravity of greater than 1 will segregate at the bottom of the reservoir 60 while water introduced to the reservoir 60 will float on top. In a system where the feed line 22 carries an alternative liquid substance, the system would work with a liquid additive having a greater specific gravity than the flow substance.

The exemplary system is designed for low-pressures and low-feed volumes system in the range of about 15 to 50 pounds per square inch (“PSI”) of pressure and in the range of about 0.1 to 15 gallons per minute (“GPM”) flow rate. (Throughout this disclosure “gallons” will be U.S. gallons.) It is understood by the inventor that the system may be scaled to handle higher pressures and higher flow volumes using the concepts taught herein.

The system maintains a desired pressure with flow line pressure regulation module 20, herein referred to as a regulator. The exemplary system uses a 20, 25, or 30 PSI regulator. The system may be adapted to employ regulators in the range from 15 and 50 PSI. The feed line 22 that continues after the regulator 20 has a fluid flow stream useable by the system. A manifold 10 is attached to the feed line 22 after regulator 20 with feed coupler 24, which may be a standard threaded hose coupler, or a standard plumbing coupler. Manifold 10 additionally includes a manifold restrictor 12, to create a slight regional pressure drop in the fluid flowing within the manifold 10. In the exemplary embodiment the pressure drop is in the range of about 3 to 5 PSI; about a 12 to 25 percent drop. An inlet tube tap 14 is provided before the manifold restrictor 12, and a feed tube tap 16 is provided after the manifold restrictor 12. After feed tube tap 16 is delivery line coupler 26, which may be a standard threaded hose coupler, or a standard plumbing coupler, and permits manifold 10 to connect to delivery line 28. Delivery line 28 communicates the blended feed flow and additive to the use point.

Manifold 10 creates a relative high-pressure area before the manifold restrictor 12, which causes a portion of the fluid stream to flow from feed line 22 at inlet tap 14. Additionally, the manifold 10 has a relative low-pressure region after manifold restrictor 12. Manifold 10 operates to feed a stream of liquid additive into the fluid flow after the restrictor 12, at feed tube tap 16. The flow controlled inlet line 30 receives the portion of the stream tapped off feed line 22 at inlet tap 14 and communicates that portion into the interior 66 of the reservoir 60.

Reservoir 60 is designed to hold a volume of additive with a higher specific gravity than the fluid flowing from feed line 22. In the exemplary embodiment, the fluid in feed line 22 is water and the additive in the reservoir interior 66 is a liquid fertilizer that is denser than the feed line 22 water. The exemplary liquid fertilizer may be formed by combining water soluble dry fertilizer and water, at a relatively precise ratio.

Exemplary inlet line 30 has an inlet restrictor 34 and a check valve 36. Inlet restrictor 34 ensures that the pressure in inlet line 30 remains at the optimal level. The optimal level provides a uniform rate of flow that can be introduced into reservoir interior 66 by diffusion interface 50 without agitating the contents of reservoir 60. Inlet check valve 36 may be inserted into inlet line 30 to prevent fluid flow from the reservoir 60 back toward the manifold 10. This could primarily be a concern at initiation or cessation of operation of the system, though either or both placement of the manifold 10 above the top of the body and termination of inlet line 30 above the additive level inside reservoir 60 would greatly reduce, if not eliminate, this concern.

As water enters reservoir interior 66 from inlet line 30, it is deposited on top of the additive (not shown) contained therein. The additional fluid that enters the closed reservoir interior 66 induces excess liquid to find an outlet. The liquid finds an outlet through flow controlled feed line 40, which extends into reservoir 60 as draw tube 64. The flow controlled feed line 40 communicates liquid additive through draw tube 64 from the bottom of the reservoir 60 to the manifold 10, at the feed tube tap 16. A filter (not shown) may be added to the end of draw tube 64 to guard against blockage of the draw tube 64 by any particles.

Exemplary feed line 40 has a feed restrictor 44 and a feed check valve 46. Feed restrictor 44 ensures that the flow rate through feed line 40 remains at the optimal level, or in other words pressure compensated. Feed check valve 46 is inserted into exemplary feed line 40 to prevent fluid flow from the manifold 10 back toward the reservoir 60. This could primarily be a concern at initiation or cessation of operation of the system, and prevents dilution of the additive within reservoir interior 66.

Inlet restrictor 34 and feed restrictor 44 complement each other to maintain a uniform flow of liquid both into and out of the reservoir 60. Inlet restrictor 34 needs to be of a flow greater than the feed restrictor 44, but inlet restrictor 34 should be restrictive enough to compliment the diffusion interface 50 in ensuring a gentle introduction to the contents of reservoir 60.

In the exemplary embodiment, inlet restrictor 34 and feed restrictor 44 effect a restriction in flow within an acceptable pressure range. In the exemplary embodiment that range is approximately 15 to 50 PSI. Inlet restrictor 34 ensures that the input flow is restricted to a particular quantity per time rate, at the given pressure range. Additionally, the feed restrictor 44 ensures the output flow is restricted to a particular quantity per time rate, at the given pressure range. A suitable inlet restrictor 34 may reduce the inlet flow to within the range of about 1 to 11 gallons per hour (“GPH”), with the exemplary flow rate being about 2 GPH and a complimentary suitable feed restrictor 44 would reduce the feed flow to within the range of about 0.1 to 10 GPH, with the exemplary rate being about 0.5 GPH, or alternatively, 1.0 GPH. In the exemplary system the given pressure is ensured to be reliably within an acceptable range by pressure regulator 20. If a particular fluid flow system possesses a stable pressure within the acceptable range, the specific pressure regulator 20 device may be unnecessary. Exemplary inlet and feed restrictors (34, 44) operate with uniformity within 15 to 50 PSI to ensure uniformity of flow and injection rate accuracy.

Exemplary liquid reservoir 60 is constructed in parts and includes cap 62, and sump pan 70. Cap 62 forms the top of reservoir 60. In the exemplary embodiment diffusion interface 50 is located in the center and top of cap 62. Diffusion interface 50 receives the end of flow controlled inlet line 30, which encompasses inlet tube outlet 38. Additionally, diffusion interface 50 may offer an access point for draw tube 64 to exit the reservoir interior 66.

Diffusion interface 50 further comprises a dispersion surface 52 to breakup the stream of fluid exiting inlet tube outlet 38 internal to the diffusion interface 50. Since the content of the reservoir 60 is both an additive and the fluid diverted from the feed line 22, and these contents are not separated by a membrane, there is an opportunity for agitation, which can disturb the performance of the device. The dispersing surface 52 reduces the amount and degree of agitation. The inlet tube outlet 38 is oriented to direct a fluid flow portion onto the dispersion surface 52. Exemplary dispersing surface 52 is a flat internal surface of a fill structure 54 perpendicular to the fluid flow direction of travel, which disturbs the unified flow of the stream after it leaves inlet tube outlet 38. A perpendicular orientation ensures the fluid flow portion intersects the dispersion surface 52 and is adequately dispersed but other angles of intersection are envisioned within the scope of this disclosure, and may also be suitable for particular situations. In the exemplary embodiment, inlet tube outlet 38 is spaced apart from and non-parallel to the dispersion surface 52.

Dispersing surface 52 and inlet tube outlet 38 are positioned within diffusion interface 50 so as to be maintained above the uppermost level of the fluid contained within reservoir 60. Maintaining dispersing surface 52 and inlet tube outlet 38 in an area of air above the high-fluid level limit 68 enables proper dispersion. In situations where dispersing surface 52 and inlet tube outlet 38 would be disposed in the fluid, a fluidic agitation effect may still stir the fluid, causing the additive and incoming water to mix.

Other configurations are envisioned that may work equally as well, as long as those configurations effect disrupting the incoming fluid flow so that the incoming fluid is deposited relatively gently on the surface of the additive contained in the reservoir 60. Positioning inlet tube outlet 38 above the level of the additive inside reservoir 60 may play another important factor in avoiding agitation of the additive. Dispersing the stream, the fluid coming into the reservoir interior 66 creates less turbulence in the additive, or additive and water mixture, contained in the reservoir 60, maintaining a distinct layer of separation between the two fluids of differing specific gravity.

Exemplary diffusion interface 50 further comprises a fill structure 54 that provides fluid communication from the outside to the reservoir interior 66. Reservoir 60 may be refilled with additional additive via fill structure 54. Exemplary fill structure 54 has a valve 56 to prevent unwanted flow through fill structure 54.

The diffusion interface 50 is a primary component for providing diffusion of the incoming fluid stream, though the flow rate of inlet restrictor 34 may also contribute to the total dispersion effect to result in minimal agitation of the reservoir contents. Alternative manners of diffusion may supplant or augment those contained herein for implementation on systems with higher pressure or flow rates. In alternative embodiments, the plumbing configuration may act as either or both a restrictor and a diffuser, effecting non-agitating addition of the fluid flow from the inlet line 30 into the additive contained in reservoir 60.

Sump pan 70 forms the bottom of reservoir 60, and, when oriented in an upright position, creates sump 72, since liquid contained in the reservoir interior 66 will collect in the sump pan 70. The open end of draw tube 64 is positioned in sump 72 to provide fluid communication of the additive into feed line 40 and on to the manifold 10. Draw tube 64 will communicate water from the reservoir interior 66 if the additive is depleted or if the water and additive become mixed from agitation. The sump 72 also provides for sediment to collect. In an alternative exemplary embodiment, sump 72 may be formed from a clear material, to provide the capacity to monitor either or both additive and sediment levels.

Exemplary drain 74 is provided in the bottom-most portion of sump pan 70 to permit any contents of reservoir 60, including sediment, to be drained from the interior 66. A valve 76 is provided to control the flow of any material from the interior 66 through drain 74. A drain tube 64 is positioned with one end in sump 72, so it may provide fluid communication of a liquid settled in sump 72 to the exterior of the reservoir 60 without traveling to the manifold 10.

In the exemplary embodiment the sides of reservoir 60 may be partially, sectionally, regionally, or completely transparent, permitting one to observe the reservoir interior 66. Additionally, draw tube 64 may be transparent so one can observe the contents. This configuration enables determination of the additive level in the device. When the additive contains a color, the color can be easily seen through the reservoir 60 and the draw tube 64. When additive is in draw tube 64 the color is visible, but when non-dyed fluid is drawn into the draw tube 64, no color is seen, meaning the additive is depleted.

In alternate exemplary embodiments, feed line 22 may have a combination of a filter to catch contaminants, a flow restrictor to restrict the size of the flow through the respective line, and a one-way check valve to prevent fluid in the inlet line from flowing backward further up the feed line 22.

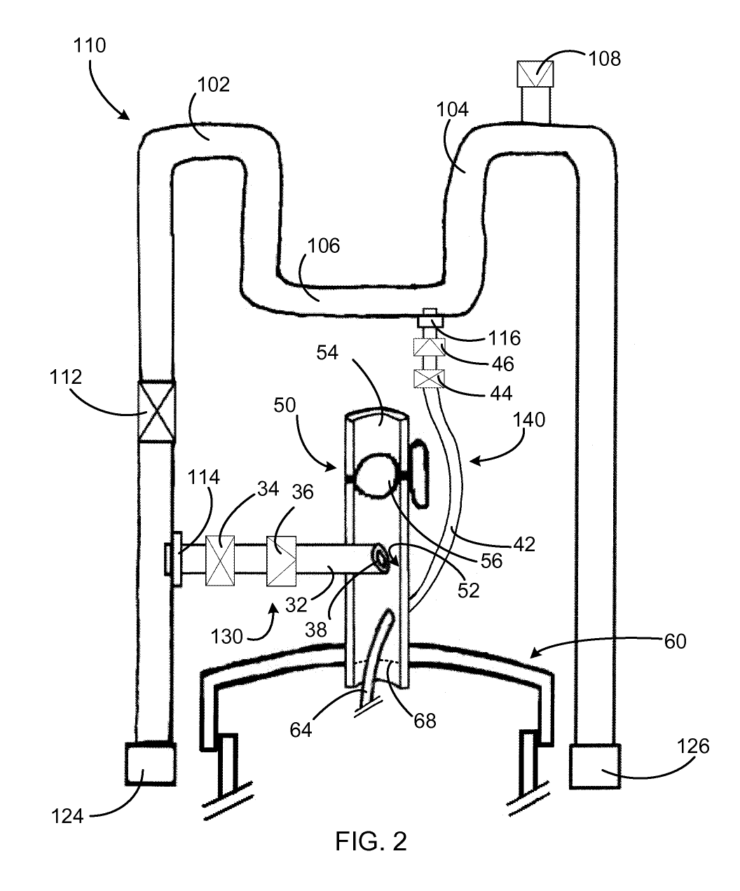

Referring now to FIG. 2, an alternate exemplary embodiment of a manifold 110 is depicted. Details that are similar to details in the initial manifold 10 are referenced by similar reference numbers in the 100's series. As such, the alternate exemplary manifold 110 includes alternate feed coupler 124, alternate manifold restrictor 112, alternate inlet tube tap 114, alternate feed tube tap 116, alternate delivery coupler 126, alternate flow controlled inlet line 130, and alternate flow controlled feed line 140. Additionally, manifold 110 includes leading gooseneck 102, trailing gooseneck 104, trap 106, and check valve 108. This configuration permits the isolation of water containing additive, otherwise referred to as treated water, in the trap 106 of in the manifold. The leading gooseneck 102 and the trailing gooseneck 104 prevent the treated water from leaving the trap until the system is in operation with flowing fluid. Some additives may be caustic or corrosive to components of the feed line if they were to remain in static contact for an extended period of time. Since irrigation systems frequently operate intermittently, such contact can occur if treated water is not sequestered in a trap constructed of material resistant to the particular additive. Check valve 108 may provide an anti-vacuum effect, to prevent flow problems such as a vapor lock. The check valve 108 permits the introduction of outside air when a vacuum develops inside trailing gooseneck 104.

The described exemplary device permits a dynamically adjustable controlled dosage of additive into a fluid flow, which makes a treatment flow. An example of such a treatment flow is a garden irrigation system that delivers both water and fertilizer to the plants. To get the benefit of the device one must make calculations based on the particular flow system and additive, such as the total system flow rate, the desired nitrogen concentration, and the efficacy of the particular fertilizer.

In the exemplary system, the concentration is being fed into a flow system with a particular unique flow character. In this instance one must know the flow rate of the particular irrigation system. Various water systems (e.g., individual wells, particular city water systems, and a particular irrigation system) can all produce differing flow rates and pressures. Consider that a particular irrigation system is configured of a particular unique combination of pipe lengths, pipe sizes, pipe routing patterns, and an assortment of varied emitters. The potential combinations are limitless.

Each type of emitter that comprises a low-flow system has a particular flow rating. This may be listed as GPH, GPM, or otherwise. In the exemplary embodiment, it is desirable to operate the system on an ounce per minute (“OPM”) basis, so the numbers must be properly converted. Emitters that list only GPH require the GPH value be divided by 60 to obtain GPM. For example, if an emitter lists a flow rate of 10 GPH, one would divide 10 by 60 to obtain the equivalent GPM of 0.16. If ounces are given, multiply by 128 ounces per gallon, to make the conversion to OPM.

In order to ensure accurate assessment of a particular system, one will test the system's flow characteristics to determine an actual total system flow. This can be accomplished by sampling each type of emitter to determine the actual flow rate of each emitter type. A manner of doing this is to turn on the system and catch the flow from each type of emitter over a given period of time. One should be attentive for emitters of a particular type that emit an atypical rate due to being remote from the water source, or improper operation.

In the exemplary embodiment this measurement taken over a one-minute period and is generally gauged in either gallons or ounces, so that the result is in either GPM's or OPM's for each type of emitter. The total flow from the total number of each type of emitter is then totaled for a total system flow rate. For example, a system with fifteen 10 GPH emitters would have a total flow rate of 2.5 GPM ((10 GPH/60 min. per hour)×15 emitters=2.5 GPM). This would then convert to 320 OPM (2.5 GPM×128 oz. per gallon=320 OPM).

Since our exemplary system has a feed line restrictor 44 that limits the feed flow from feed line 40 to 0.5 GPH, for every gallon per hour that flow by in the flow line at about 20 PSI, the total flow rate of the system must be divided by this rate. To do the calculation, the numbers must first be in the same units. 0.5 GPH is 1.067 OPM ((0.5 GPH×128 oz. per gallon)/60 min. per hour=1.067 OPM).

A system dilution ratio is the number that represents the flow volume of the system with regard to the feed flow of the system. Therefore, our exemplary system with a total flow rate of 320 OPM and a feed flow rate of 1.067 OPM will result in a dilution ratio of 300:1 for a 1 PPM concentration (320 OPM÷1.067 OPM=299.9). In the exemplary process the dilution ratio is multiplied by the desired nitrogen concentration, in PPM's, to obtain a dilution factor. For the targeted 100 PPM of the current example, the dilution factor is 29,990 (299.9×100=29,990).

In this example, one may now choose how much nitrogen to apply to the plants. The desired level of nitrogen to deliver to the plants permits one to calculate how much fertilizer to use per volume of water delivered to the plants to achieve that desired amount of nitrogen.

Most fertilizers will instruct the addition of a certain volume (e.g., in ounces) of fertilizer to a particular volume (e.g., in gallons) of water to achieve a specific concentration (typically expressed in PPM's) of nitrogen. Typical concentrations of nitrogen include 50 PPM, 100 PPM, and 200 PPM, but other concentrations may be desirable. Some fertilizers may express their efficacy generally as the volume (e.g., in ounces) of fertilizer per volume (e.g., in gallons) of water as a ratio, such as 100:1, to achieve to achieve a particular concentration (e.g., 100 PPM) of nitrogen. An example is Nutriculture® 18-6-18 Mag-Iron™ Special, by Plant Marvel Laboratories, Inc., Chicago Heights, Ill. The bag lists the number ounces to add to a gallon of water to achieve 100 PPM of nitrogen, as well as the number of ounces to add to a gallon of water for use in a proportioner, at a ratio of 100:1. For this example, the label shows that 0.074 ounces of fertilizer is to be added to a gallon of water for direct use on plants. Further, 7.4 ounces of fertilizer is to be added to a gallon of water to make a concentrate. This concentrate may then be diluted into water at a rate of 1:100, resulting in 100 gallons of fertilized water with a nitrogen concentrate of 100 PPM.

An additional way of expressing the efficacy is done by the fertilizer N-P-K rating where the first number is the percentage of nitrogen compound in the fertilizer by percentage of volume. Those skilled in the field of fertilizer calculations use at least one standard formula to calculate the amount of a particular fertilizer one must add to a particular volume of a stock fertilizer solution. The amount of fertilizer needed is equal to the sum of desired nitrogen concentration in parts per million and the dilution factor, where the dilution ratio is the larger number of the fertilizer injector ratio, this sum referred to as the dilution factor, divided by the sum of the percent of nitrogen in the fertilizer and a constant for the particular units used (desired volume of fertilizer=(N concentration×dilution ratio)÷(% N×C). The constant is know in the field to be 75 to convert to ounces per gallons, 1200 to convert to pounds per gallon, and 10 to convert to grams per liter.

In the exemplary fertilizer, 18-6-18 Mag-Iron™ Special, the nitrogen concentration is 18%. This percentage is multiplied by the conversion constant of 75 to obtain the percent nitrogen factor of 1350 (18×75=1350) for an ultimate calculation of ounces per gallon. To obtain the amount of the dry fertilizer, in ounces, to add to a gallon of water, the dilution factor is divided by the percent nitrogen factor. In the current exemplary system, using the previously calculated dilution factor 22.21 ounces of the dry fertilizer is to be added to a gallon of water (29,990÷1350=22.21) to provide a uniform 100 PPM of nitrogen to the plants, when fed through a system with a pressure regulated flow line. This combination of 22.21 ounces of dry fertilizer and one gallon of water is poured into reservoir 60 for controlled uniform delivery to the plants, which can be delivered in timed portions over an extended period of time, with a sustained, uniform nitrogen content.

In an alternate exemplary embodiment where feed line restrictor 44 is a 1 GPH restrictor the feed flow rate would be 2.13 OPM (128 oz. per gallon/60 min. per hour=2.133 OPM). The greater flow capacity may be necessary to overcome limitations due to fertilizer solubility, for example, where the required dry fertilizer volume will not completely dissolve in a single gallon of water. In that instance two gallons may be used. The larger flow restrictor guarantees a flow twice as great, resulting in an equivalent to the desired concentration.

The foregoing disclosure and description of the invention is illustrative and explanatory thereof. Various changes in the details of the illustrated construction may be made within the scope of the appended claims without departing from the spirit of the invention. Additionally, patent application Ser. No. 12/860,312, filed 20 Aug. 2010, and patent application No. 61/235,353, filed 20 Aug. 2009 by the present inventor are incorporated herein by reference for all allowable purposes, and to ensure prior claimed elements, yet to be included in an allowed claim, may be subsequently claimed. The present invention should only be limited by the following claims and their legal equivalents.

I claim:

1. A liquid additive feed system integrateable into a pressure controlled flow line comprising:
a manifold having a conduit to communicate a directional fluid flow;
a manifold restrictor positioned in the conduit to effect a decrease in pressure in the directional fluid flow;
an inlet line in fluid communication with the manifold conduit prior to the manifold restrictor, relative to the directional fluid flow;
a feed line in fluid communication with the manifold conduit subsequent to the manifold restrictor, relative to the directional fluid flow;
a reservoir with a common interior for containing an additive and accepting a fluid flow portion of the directional fluid flow;
the reservoir in fluid communication with the manifold via both the inlet line and the feed line;
a diffusion interface in fluid communication with, and intermediate to, the inlet line and the reservoir;
the diffusion interface comprising a fill structure internal surface and an inlet tube outlet; and
the inlet tube outlet spaced apart from and non-parallel to the fill structure internal surface.

2. The liquid additive feed system of claim 1 further comprising:
the reservoir having a high fluid level limit; and
the inlet tube outlet oriented to direct a fluid flow portion onto the fill structure internal surface above the high fluid level limit.

3. A pressure controlled flow line fed liquid additive feed system comprising:
a manifold having a conduit to communicate a directional fluid flow;
a manifold restrictor positioned in the conduit to effect a decrease in pressure in the directional fluid flow;
an inlet line in fluid communication with the manifold conduit prior to the manifold restrictor, relative to the directional fluid flow;
a feed line in fluid communication with the manifold conduit subsequent to the manifold restrictor, relative to the directional fluid flow;
a reservoir with a common interior for containing an additive and accepting a fluid flow portion of the directional fluid flow;
the reservoir having a high fluid level limit;
the reservoir in fluid communication with the manifold via both the inlet line and the feed line;
a diffusion interface in fluid communication with, and intermediate to, the inlet line and the reservoir;
the diffusion interface comprising a fill structure internal surface and an inlet tube outlet;
the inlet tube outlet spaced apart from and non-parallel to the fill structure internal surface; and
the inlet tube outlet oriented to direct a fluid flow portion onto the fill structure internal surface above the high fluid level limit.
